(19) United States
(12) Patent Application Publication
(10) Pub. No.: US 2009/0153841 A1
(43) Pub. Date: Jun. 18, 2009

(54) OPTICAL SCANNING DEVICE

(76) Inventors: Wil Ophey, Eindhoven (NL); Sjoerd Stallinga, Eindhoven (NL); Pim Theo Tuyls, Eindhoven (NL); Antonius Hermanus Maria Akkermans, Eindhoven (NL); Boris Skoric, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 11/573,947

(22) PCT Filed: Aug. 15, 2005
(86) PCT No.: PCT/IB05/52685

§ 371 Date: Jan. 30, 2009

(30) Foreign Application Priority Data
Aug. 23, 2004 (EP) 04104035.3

(51) Int. Cl. G06K 9/74

(52) U.S. Cl. 356/71

(57) ABSTRACT

An optical identifier (1) can be used as a Physical Unclonable Function for producing a speckle pattern, as a response, upon being challenged with a light beam, as a challenge. This property can be used for identification of the optical identifier or of an object attached thereto, for the authentication of an information carrier or for generation of transaction keys. Since the response obtained in response to given challenge is highly sensitive to the relative position of the optical identifier, light beam source and detector for the speckle pattern, this relative position has to be accurately adjusted to reliably obtain the same response to a given challenge. To this aim, an optical identifier is proposed having an alignment area (3) for splitting an incident beam into distinct beams (6, 7) which can be detected as alignment signals (10a, 10b, 10c, 10d) on a detector (8) and used for the monitoring and for the adjustment of said relative position.

The invention relates to an optical identifier, a device comprising the same and an apparatus and a method for positioning an optical identifier.

The use of “physically unclonable functions” (PUFS) for security purposes is known, e.g. from U.S. Pat. No. 6,584,214. Incorporating a PUF into a device such as a smart card, chip, or storage medium makes it extremely difficult to produce a “clone” of the device. “Clone” means either a physical copy of the device or a model that is capable of predicting the input-output behavior of the device with reliability. The difficulty of physical copying arises because the PUF manufacturing is an uncontrolled process and the PUF is a highly-complex object. Accurate modeling is extremely difficult because of the PUF's complexity; slightly varying the input results in widely diverging outputs. The uniqueness and complexity of PUFs makes them well suited for identification, authentication or key generating purposes.

Optical PUFs can consist of a piece of, e.g., epoxy containing glass spheres, air bubbles or any kind of scattering particles. The epoxy can also be replaced by some other transparent means. Generally, a PUF is referred to as an identifier hereinafter. Shining a laser through a PUF produces a speckle pattern which depends on properties of the incoming wave front and on the internal structure of the PUF. The input, i.e. an irradiation beam, can be varied by shifting or tilting an irradiation source or by changing the focus. Even a slightly changed input may greatly affect the output, i.e. the speckle pattern.

When a smart card or the like comprising a PUF is put into a “reader” challenges may be applied to it in order to verify its identity. For this, the angle of incidence of a probing laser beam must be set within an accuracy to a predetermined angle of incidence, to repeatedly obtain the same output to a given input. Also there is a need for a certain accuracy for the exact position of the PUF in the reader. The better the actual position and orientation of the PUF meets the predetermined values the less the chances that the PUF will be identified wrongly due to a deviant speckle pattern.

It is an object of the invention to provide an optical identifier with means to measure its position and its orientation relative to an optical system wherein it is inserted. Further objects of the invention are to provide an apparatus and a method for positioning such an optical identifier.

According to the invention, the first object is achieved by an optical identifier as claimed in claim 1.

According to the invention, the further objects are achieved by respectively an apparatus as claimed in claim 10 and a method as claimed in claim 13.

The invention is based on the insight that the irradiation used for challenging the optical identifier may be used for a measurement of the position and/or orientation of the optical identifier. When an area of the optical identifier provides a signal which may be altered in some way by the optical identifier but nevertheless gives a reliable possibility to detect the position and/or orientation of said area and thus of the optical identifier, said signal can be used for positioning of the optical identifier. It is thus proposed by the present invention to provide an optical identifier comprising such an alignment area by which the position and/or orientation of the PUF can be detected using the response signals of said alignment area to an incident irradiation.

It shall be noted that the term “positioning of an optical identifier” does not only include the mere adjustment of the position and/or orientation of the identifier itself but also an adjustment of the position and/or orientation of the identifier relative to other parts of an optical system, like for example a reader, or detector. This also may include the adjustment of the position and/or orientation of the detector instead of that of the identifier. The same can be repeated for the source of the irradiation beam. It shall further include the adjustment of the position and/or orientation of a device which carries or comprises the optical identifier, e.g. a credit card.

In an embodiment, said irradiation beam is a beam of coherent light. By an irradiation of a laser the occurrence of interferences if utilized to produce a more complex speckle pattern. It shall be noted that by the term “light” not only visible light is meant, but also adjacent parts of the spectrum, such as infrared and ultraviolet light.

In another embodiment of the optical identifier according to the invention, said alignment area comprises a structure with at least three surface planes respectively angled against each other which are to be exposed to said irradiation beam. Upon being irradiated by a single irradiation beam such an alignment area will produce at least three distinct beams, or split beams, which can be used to detect the orientation and/or position of said optical identifier.

In a preferred embodiment of the optical identifier, said alignment area is mechanically protected against physical changes by protection means. For example mechanical wear could change the alignment area so it produces signals which would be incorrectly interpreted. Said protection could even be provided by the part optical identifier itself which produces the speckle pattern. If the alignment area is arranged within that part of the optical identifier it is protected by the part of the identifier surrounding it, so there is no need for an additional cover layer. If the optical identifier is attached to a device such as a smart card or integrated into such a device, the alignment area can even be on the boundary surface between identifier and device while being protected against physical changes by either the device and the identifier itself.

In a further embodiment of the optical identifier said alignment area has substantially the shape of a pyramid. When the irradiation beam is directed to the tip of the pyramid perpendicular to the base plane of the pyramid the side planes will produce four beams, which can be detected on a detector so as to obtain as many signals, from which position and/or orientation information can be easily derived.

In another embodiment of the optical identifier said pyramid is a Fresnel shaped or blazed grating shaped pyramid. For optical purposes the structure does not have to have the complete shape of a pyramid in a geometric sense. For example, a Fresnel shaped pyramid will produce the same signals as a “normal” pyramid but is substantially flat in comparison. It is important that a number of signals are produced which can be used to derive position and/or orientation information, while the actual shape of the alignment area is of much less importance.

Advantageously, the optical identifier according to the invention can be embedded in or permanently associated to a device for the purpose of identification, authentication and/or key generation. Such a device may be:

a storage medium for copy protected content,

a storage medium requiring anti-counterfeiting measures, e.g. a smart card, a credit card, or an ID card,

a microprocessor or another IC which needs to be uniquely identified,

a terminal such as an ATM machine.

According to the application, the optical identifier may be a unique identifier, for uniquely identifying said device, or one out of a family of equal optical identifiers.

In an embodiment of the apparatus for positioning an optical identifier according to the invention, the detection means comprises a plurality of detection areas provided for detecting the alignment signals, in particular at least one detection area for each alignment signal.

In a further embodiment of the apparatus for positioning an optical identifier, said detection areas of said detection means each comprise a plurality of detection sub-areas each for detecting a part of at least on of said alignment signals. It has been found that an apparatus of the previous embodiment and in particular an apparatus of this embodiment are well suited for detecting said alignment signals and for positioning the identifier accordingly.

In the following, the invention will be explained further in detail with reference to the figures, in which:

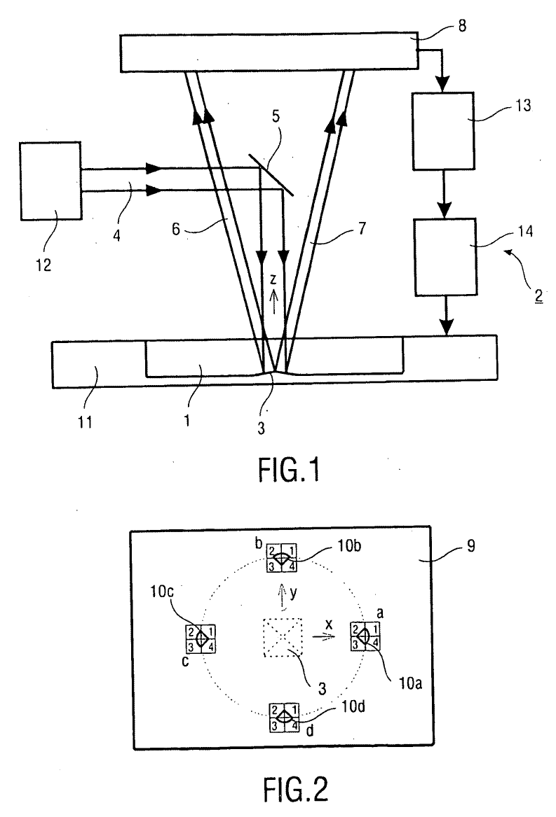

FIG. 1 shows a sectional view of an arrangement of an optical identifier and an apparatus for positioning the identifier according to the invention,

FIG. 2 shows a plan view of the arrangement of FIG. 1 illustrating the signals produced by the identifier, and

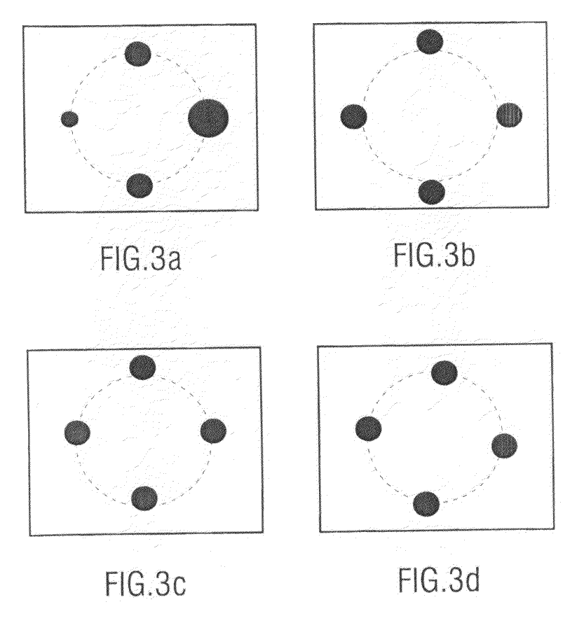

FIGS. 3a to 3d show different signals indicating different positions or orientations of the optical identifier.

FIG. 1 shows a sectional view of an arrangement of an optical identifier 1 and an apparatus 2 for positioning the identifier 1 according to the invention. The bottom surface of the identifier 1 which is a boundary between said identifier and a device 11 comprising it is provided with an alignment area 3 of a pyramid shaped structure. When said identifier 1 is, for example, attached to or integrated into an information carrier 11 said alignment area 3 is protected by said identifier 1 and said information carrier 11. A light beam 4 produced by a source 12 is directed to said alignment area 3 by a mirror 5. It enters the identifier 1 and will only partially be scattered. The un-scattered part of the beam 4 will be reflected by the alignment area 3 and divided into four sub-beams, two of which are shown and indicated by 6 and 7. These reflected beams 6, 7 will partially be transmitted through the identifier 1 and will be detected by a detector 8, which may also be used to detect the speckle pattern identifying the identifier 1.

The detection or alignment signals corresponding to the spots produced by of said beams 6, 7 on the detector 8 are used by a processing means 13, e.g. including a microprocessor, to derive information about position and/or orientation of said identifier 1. A positioning means 14 adjusts the position and/or orientation of said identifier 1 using said position and/or orientation information, for instance, by using piezoelectric actuators.

FIG. 2 shows a plan view of the arrangement of FIG. 1 illustrating the signals from the four sub-beams 6, 7 and the two not shown in FIG. 1 produced by the identifier 1 which corresponds to an image 9 on said detector 8. Said image 9 comprises a speckle pattern (not shown) and four bright spots 10a, 10b, 10c, 10d originating from the pyramid structured alignment area 3. The bright spot 10c is the image of sub-beam 6, while 10a is that of sub-beam 7. These four bright spots 10a to 10d will change in size or position due to a shift or rotation of said identifier 1. Within said detector 8 or within said image 9, around every spot 10a to 10d a four-quadrant detection area a, b, c, d can be defined, thus said spots 10a to 10d can be extracted from the detector signal. From the detector-area signals a1 through d4 which correspond, for example, to the total amount of light power falling on the particular detector area a, b, c, d position and/or orientation information can be derived using the following equations:

Δx=(a1+a2+a3+a4)−(c1+c2+c3+c4)

Δy=(b1+b2+b3+b4)−(d1+d2+d3+d4)

Δz=(a1+a4+b1+b2+c2+c3+d3+d4)−(a2+a3+b3+b4+c1+c4+d1+d2)

Δα=(b1+b2+d1+d2)−(b3+b4+d3+d4)

Δβ=(a1+a4+c1+c4)−(a2+a3+c2+c3)

Δγ=(a1+a2+b2+b3+c3+c4+d1+d4)−(a3+a4+b1+b4+c1+c2+d2+d3)

Of course these signals can be normalized by a division through the sum of the used detector areas in every formula.

FIG. 3a to 3d show different signals indicating different positions or orientations of the optical identifier. In FIG. 3a the spot on the right is increased in size and the spot on the left is decreased. This corresponds to a lateral shift in the x-direction (see FIG. 2). When the identifier 1 is to far away from the detector 8 in the z-direction (see FIG. 1), this will result in an increased distance between the spots as indicated in FIG. 3b. When the optical identifier 1 is tilted around the x- or y-axis only two opposing spots are shifted in a corresponding direction indicating the tilt. For example, a tilt round the x-axis of FIG. 2 leads to shifted spots as shown in FIG. 3c. A tilt around the z-axis will result in rotated spot positions as shown in FIG. 3d.

The embodiment described above is chosen for its adequacy to illustrate the present invention. It has to be noted that the invention is not limited to this embodiment or to the details shown in the Figures.

The pyramid shown in FIG. 1 may be extending in the z-direction or in an opposite direction, i.e. it may be protruding or indented. It does not have to be located on the surface of the identifier 1 since it also may be arranged in its inside. The alignment area 3 may have a different shape, it could be a tetrahedron or a “pyramid” with five or more sides instead of four sides. It does not have to have a symmetric shape though it may be easier to derive information from symmetric signals. Since the important feature is the generation of different signals it does not have to be a “real” pyramid, it also could be Fresnel shaped or comprise a grating or even have any other suitable shape. The alignment area 3 could further comprise different parts which are located in or on different parts of said identifier 1.

The paths of the irradiation beam 4 and of the signals 6, 7 shown in FIG. 1 could be also be different ones. The irradiation 4 may be applied directly to the identifier 1 or be redirected by more than one mirror 5. There could also be mirrors 5 redirecting the alignment signals 6, 7, 10a, 10b, 10c, 10d. The irradiation 4 could be applied in any direction to the identifier 1.

Although it is preferred that the number of detection areas corresponds to the number of sub-beams or alignment signals, it is not necessary to define a distinct number of detection areas, and it is also not necessary to divide said detection areas into sub-areas.

The invention is also not limited to the specific type of optical identifier as described above which produces a speckle pattern when it is crossed by light. For example, another suitable arrangement could comprise an optical identifier 1 with a relief on a surface which contains the identification information, while the alignment area 3 could also be arranged on said surface.

The present invention gives an improvement to optical identifiers for, e.g., smart cards. The present invention provides identifiers which can be adjusted in their position and/or orientation relative to a reading apparatus with virtually any accuracy. For example, if desired, it is possible to adjust the position of an identifier within a range of 10 μm and the orientation within a range of 0.1 mrad. Further, the present invention provides an apparatus and a method for positioning a non-clonable optical identifier which can be incorporated into a reading system for optical identifiers.

Although the invention has been elucidated with reference to an apparatus for adjusting the relative position of an optical identifier within an optical system, it will be evident that other applications are possible, for example simply the monitoring and validation of said relative position. The scope of the invention is therefore not limited to the embodiments described above.

It must further be noted that the term “comprises/comprising” when used in this specification, including the claims, is taken to specify the presence of stated features, integers, steps or components, but does not exclude the presence or addition of one or more other features, integers, steps, components or groups thereof. It must also be noted that the word “a” or “an” preceding an element in a claim does not exclude the presence of a plurality of such elements. Moreover, any reference signs do not limit the scope of the claims; the invention can be implemented by means of both hardware and software, and several “means” may be represented by the same item of hardware. Furthermore, the invention resides in each and every novel feature or combination of features.

The invention can be summarized as follows. An optical identifier 1 can be used as a Physical Unclonable Function for producing a speckle pattern, as a response, upon being challenged with a light beam, as a challenge. This property can be used for identification of the optical identifier or of an object attached thereto, for the authentication of an information carrier or for generation of transaction keys. Since the response obtained in response to given challenge is highly sensitive to the relative position of the optical identifier, light beam source and detector for the speckle pattern, this relative position has to be accurately adjusted to reliably obtain the same response to a given challenge. To this aim, an optical identifier is proposed having an alignment area 3 for splitting an incident beam into distinct beams 6, 7 which can be detected as alignment signals 10a, 10b, 10c, 10d on a detector 8 and used for the monitoring and for the adjustment of said relative position.

1. Optical identifier (1) comprising at least one alignment area (3) of a predetermined spatial structure capable of producing at least three separate beams (6, 7) in response to an incident irradiation beam (4), the orientation of said beams (6, 7) being indicative of a position and/or orientation of said optical identifier (1) relative to a reference position and/or orientation within an optical system (5, 8, 12).

2. Optical identifier (1) as claimed in claim 1, wherein said irradiation beam (4) is a beam of coherent light.

3. Optical identifier (1) as claimed in claim 1, wherein said alignment area (3) comprises a structure with at least three surface planes respectively angled against each other which are to be exposed to said irradiation beam (4).

4. Optical identifier (1) as claimed in claim 1, wherein said alignment area (3) is mechanically protected against physical changes by protection means (11).

5. Optical identifier (1) as claimed in claim 1, wherein said alignment area (3) has substantially the shape of a pyramid.

6. Optical identifier (1) as claimed in claim 5, wherein said pyramid is a Fresnel shaped or blazed grating shaped pyramid.

7. Device (11) comprising an optical identifier (1) as claimed in claim 1.

8. Device (11) as claimed in claim 7, wherein said optical identifier (1) is uniquely identifying said device.

9. Device (11) as claimed in claim 7, wherein said device is a smart card, a credit card, an id card or a data carrier.

10. Apparatus (2) for positioning an optical identifier (1) comprising at least one alignment area (3) of a predetermined spatial structure capable of producing at least three separate beams (6, 7) in response to an incident irradiation beam (4), the orientation of said beams (6, 7) being indicative of a position and/or orientation of said optical identifier (1) relative to a reference position and/or orientation within the apparatus (2), wherein said apparatus (2) comprises:
an irradiation source (5, 12) for applying said irradiation beam to said alignment area (3),
detection means (8) for detecting alignment signals (10a, 10b, 10c, 10d) produced by said sub-beams (6, 7) upon incidence on the detection means,
processing means (13) for deriving position and/or orientation information from said alignment signals (10a, 10b, 10c, 10d), and
positioning means (14) for adjusting said position and/or orientation of said optical identifier (1) to said reference position and/or orientation within the apparatus (12).

11. Apparatus as claimed in claim 9, characterized in that said detection means (8) comprises a plurality of detection areas capable of detecting said alignment signals (10a, 10b, 10c, 10d), in particular at least one detection area for each alignment signal (10a, 10b, 10c, 10d).

12. Apparatus as claimed in claim 9, characterized in that said detection areas of said detection means (8) each comprise a plurality of detection sub-areas each for detecting a part of at least one of said alignment signals (10a, 10b, 10c, 10d).

13. Method for positioning an optical identifier (1) comprising at least one alignment area (3) of a predetermined spatial structure capable of producing at least three separate beams (6, 7) in response to an incident irradiation beam (4), the orientation of said beams (6, 7) being indicative of a position and/or orientation of said optical identifier (1) relative to a reference position and/or orientation within an optical system (5, 8, 12), wherein said method comprises the steps of:
applying said irradiation beam to said alignment area (3),
detecting alignment signals (10a, 10b, 10c, 10d) produced by said sub-beams (6, 7) upon incidence on detection means,
deriving position and/or orientation information from said alignment signals (10a, 10b, 10c, 10d), and
adjusting said position and/or orientation of said optical identifier (1) to the reference position and/or orientation using said position and/or orientation information.
